(19) United States
(12) Patent Application Publication
(10) Pub. No.: US 2024/0253926 A1
(43) Pub. Date: Aug. 1, 2024

(54) STRAP STORAGE WINDING STRUCTURE FOR CONTRACTION TENSIONER

(71) Applicant: NINGBO EASYLIFTING IMPORT AND EXPORT CO., LTD, Ningbo (CN)

(72) Inventor: Yancheng PAN, Ningbo (CN)

(73) Assignee: NINGBO EASYLIFTING IMPORT AND EXPORT CO.,LTD, Ningbo (CN)

(21) Appl. No.: 18/312,520

(22) Filed: May 4, 2023

(30) Foreign Application Priority Data
Feb. 1, 2023 (CN) 202320095153.3

(51) Int. Cl. B65H 18/10

(52) U.S. Cl. CPC B65H 18/10; B65H 2403/941

(57) ABSTRACT

The present disclosure discloses a storage strap winding structure for a contraction tensioner, including a ratchet strap tension apparatus, a movable strap, a strap winding shaft, etc. Mainly, the strap winding shaft internally provided with a mandrel which coaxially penetrates, and a strap outlet groove exposing the mandrel is arranged on the strap winding shaft. In this way, it is only necessary to connect a winding end of the movable strap to a mandrel through a strap outlet groove, and the winding end can be wound on the strap winding shaft layer by layer by the rotation of the strap winding shaft to form a storage strap. Obviously, due to the design of the mandrel and the strap outlet groove, the winding end of the movable strap does not need to pass before sewing and connecting, thus ensuring the simplification of the production process. In addition, the strap winding shaft only undertakes the layer-by-layer winding of the movable strap, but the winding end is connected to the mandrel, therefore, when the wound movable strap is completely released in actual use, the winding end will not break and damage the strap winding shaft, thereby not only ensuring the connection reliability of the winding end, but also avoiding affecting the subsequent normal use of the strap tensioner.

### CROSS-REFERENCE TO RELATED APPLICATION

The present disclosure claims priority to Chinese Patent Application No. 202320095153.3 filed on Feb. 1, 2023, the disclosure of which is incorporated herein by reference in its entirety.

### TECHNICAL FIELD

The present disclosure relates to a storage strap winding structure, in particular to a storage strap winding structure for a contraction tensioner.

### BACKGROUND

At present, a strap tensioner is mainly composed of a ratchet strap tension apparatus, a movable strap, etc. The movable strap has a tension end and a winding end. The tension end can be driven by the ratchet strap tension apparatus to form tension and the winding end is windingly arranged in a storage strap winding structure arranged at an end portion of a fixed seat of the ratchet strap tension apparatus for temporary and orderly winding, specifically, one strap winding shaft is arranged in the end portion of the fixed seat, the winding end of the movable strap is fixed on the strap winding shaft and wound on the strap winding shaft layer by layer with the rotation of the strap winding shaft to form a tape storage. However, in the above storage strap winding structure, the winding end of the movable strap is passed through a preset hole-groove on the strap winding shaft, and then the connection is sewn by the string to connect to the strap winding shaft, which makes the production process more troublesome by passing through and then sewing the connection in the actual processing process. In addition, the design of the strap winding shaft not only undertakes the layer-by-layer winding of the movable strap, but also serves as a connecting component of the winding end, which can prevent the winding end from being detached from the strap winding shaft when the movable strap is completely released. However, since the strap winding shaft is generally made of plastic, the design of the hole-groove on the strap winding shaft reduces the strength of the whole strap winding shaft. Therefore, when the wound movable strap is completely released in actual use, the winding end generally is pulled off the hole-groove and then is directly detaches from the strap winding shaft, which will cause the breakage and damage of the strap winding shaft, thus affecting the subsequent normal use of the strap tensioner.

### SUMMARY

The technical problem to be solved by the present disclosure is to overcome the defects of the related art, a storage strap winding structure for a strap tensioner with convenient manufacture and reliable connection is provided.

The technical problem of the present disclosure is realized by the following technical schemes.

A storage strap winding structure for a contraction tensioner includes a ratchet strap tension apparatus and a movable strap. A strap winding shaft is arranged in an end portion of a fixed seat of the ratchet strap tension apparatus. The movable strap has a tension end and a winding end, and the tension end is driven by the ratchet strap tension apparatus to form tension. The strap winding shaft internally provided with a mandrel which coaxially penetrates, and a strap outlet groove exposing the mandrel is arranged on the strap winding shaft. The winding end is connected to the mandrel through a strap outlet groove and wound on the strap winding shaft layer by layer by the rotation of the strap winding shaft to form a storage strap.

The strap outlet groove, extending in an axial direction, is arranged on an outer surface of the strap winding shaft.

The string sleeved on the mandrel is arranged the winding end.

A hand wheel in transmission connection is arranged at an end of the strap winding shaft and drives the strap winding shaft to rotate.

A polygonal shaft and a polygonal hole forming a transmission connection are arranged between the end of the strap winding shaft and the hand wheel.

A positioning hole is arranged in the polygonal shaft, and a positioning shaft is correspondingly arranged in the polygonal hole. A transmission connection is formed between the end of the strap winding shaft, and the hand wheel via the polygonal shaft and the polygonal hole, while a positioning assembly is formed at the positioning hole and the positioning shaft.

A storage strap seat is arranged at the end portion of the fixed seat, and pivot holes are arranged at both sides of the storage strap seat. The end of the strap winding shaft extends out of the pivot hole to be in transmission connection to the hand wheel, and a stopping cap is arranged at the other end of the strap winding shaft extending out of the pivot hole.

The mandrel penetrates from the end of the strap winding shaft with the stopping cap and coaxially penetrates along an axial line of the strap winding shaft to form a connection to the hand wheel.

The hand wheel is composed of a disc-shaped wheel body and a pivot block symmetrically arranged on an outer circumferential surface of the wheel body, and a plurality of anti-slip grooves are arranged on the outer circumferential surface of the wheel body.

Compared with the related art, in the present disclosure, mainly, a mandrel which coaxially penetrates is added in the strap winding shaft and a strap outlet groove exposing the mandrel is arranged on the strap winding shaft; In this way, it is only necessary to connect the winding end to the mandrel through a strap outlet groove, and the winding end can be wound on the strap winding shaft layer by layer by the rotation of the strap winding shaft to form a storage strap. Obviously, due to the design of the mandrel and the strap outlet groove, the winding end of the movable strap does not need to pass before sewing and connecting, thus ensuring the simplification of the production process. In addition, the strap winding shaft only undertakes the layer-by-layer winding of the movable strap, but the winding end is connected to the mandrel, therefore, when the wound movable strap is completely released in actual use, the winding end will not be pulled off and cause the breakage and damage of strap winding shaft, thereby not only ensuring the connection reliability of the winding end, but also avoiding affecting the subsequent normal use of the strap tensioner.

### BRIEF DESCRIPTION OF THE DRAWINGS

FIG. 1 is a structural schematic view of the present disclosure.

FIG. 2 is a partial cross-sectional view taken along an axis of a mandrel in FIG. 1.

FIG. 3 is an exploded view of FIG. 1.

FIG. 4 is a perspective view of a strap winding shaft.

FIG. 5 is another perspective view of the strap winding shaft.

FIG. 6 is a structural schematic view of a hand wheel.

### DETAILED DESCRIPTION

An embodiment of the present disclosure will be described below in detail according to the above drawings.

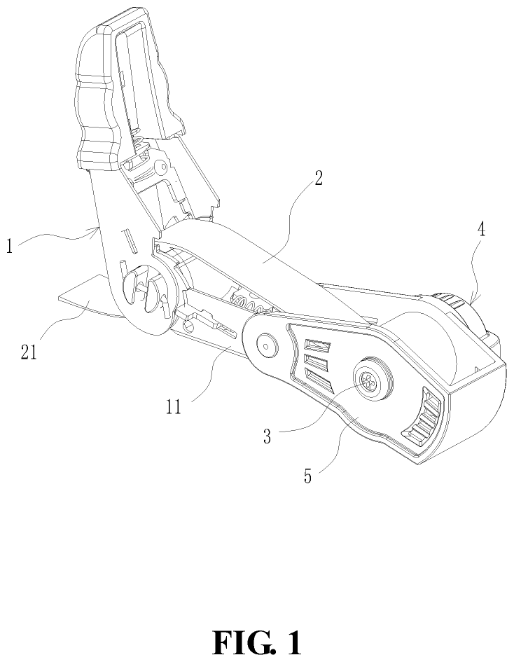

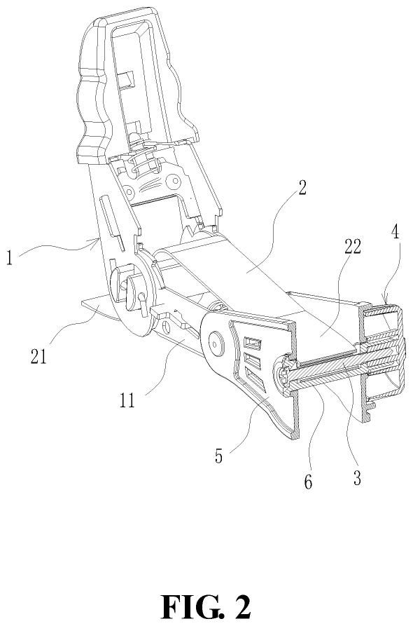

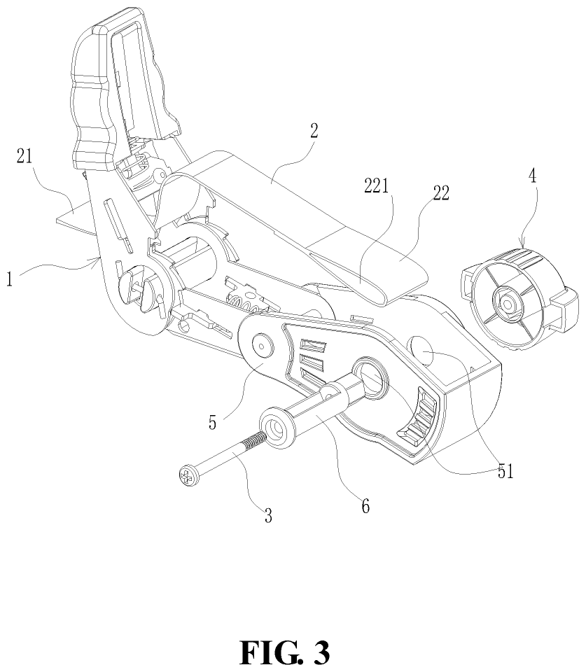

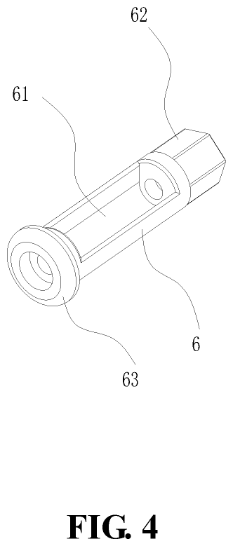

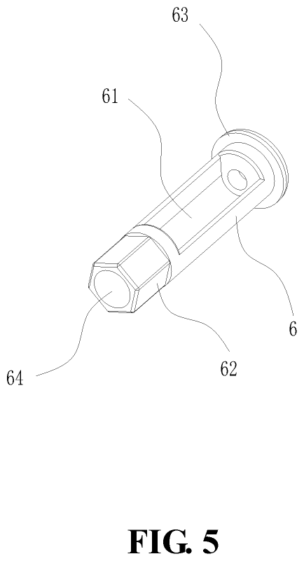

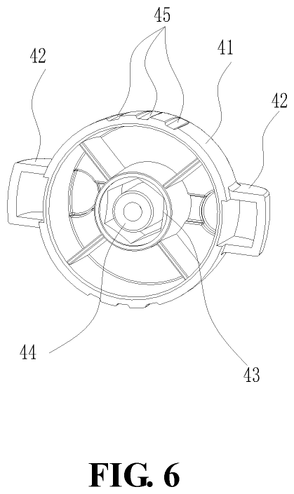

As shown in FIG. 1 to FIG. 6, 1—ratchet strap tension apparatus; 11—fixed seat; 2—movable strap; 21—tension end; 22—winding end; 221—string; 3—mandrel; 4—hand wheel; 41—wheel body; 42—pivot block; 43—polygonal hole; 44—positioning shaft; 45—anti-slip groove; 5—storage strap seat; 51—pivot hole; 6—strap winding shaft; 61—strap outlet groove; 62—polygonal shaft; 63—stopping cap; and 64—positioning hole.

A storage strap winding structure for a contraction tensioner, as shown in FIG. 1 to FIG. 3, includes a ratchet strap tension apparatus 1 and a movable strap 2. The movable strap has a tension end 21 and a winding end 22, the tension end is driven by the ratchet strap tension apparatus (1) to form tension, and a string 221 is arranged on the winding end 22.

A strap winding shaft 6 is arranged in an end portion of a fixed seat 11 of the ratchet strap tension apparatus 1, specifically, a storage strap seat 5 is arranged at the end portion of the fixed seat 11, and pivot holes 51 are arranged at both sides of the storage strap seat; the hand wheel 4 in transmission connection is arranged at the end of the strap winding shaft 6 extending out of the pivot hole 51, and the hand wheel can drive the strap winding shaft 6 to rotate, while a stopping cap 63 is arranged at the other end of the strap winding shaft 6 extending out of the pivot hole 51.

A polygonal shaft 62 and a polygonal hole 43 forming a transmission connection are arranged between the end of the strap winding shaft 6 and the hand wheel 4, such as a regular hexagonal shaft and a regular hexagonal hole in this embodiment; in addition, a positioning hole 64 is arranged in the polygonal shaft 62, and a positioning shaft 44 is correspondingly arranged in the polygonal hole 43. When a transmission connection is formed between the end of the strap winding shaft 6 and the hand wheel 4 via the polygonal shaft 62 and the polygonal hole 43, while a positioning assembly is formed at the positioning hole 64 and the positioning shaft 44.

The hand wheel 4 is composed of a disc-shaped wheel body 41 and two pivot blocks 42 symmetrically arranged on an outer circumferential surface of the wheel body, and a plurality of anti-slip grooves 45 are arranged on the outer circumferential surface of the wheel body 41.

A mandrel 3 which coaxially penetrates is arranged in the strap winding shaft 6, specifically, the mandrel 3 penetrates from the end of the strap winding shaft 6 with the stopping cap 63, coaxially penetrates along an axial line of the strap winding shaft 6, which can form a connection to the hand wheel 4, and the mandrel 3 can be an unbreakable metal rod.

In addition, a strap outlet groove 61 exposing the mandrel 3 is arranged on the strap winding shaft 6, extended in an axial direction, and arranged on an outer surface of the strap winding shaft 6. The winding end 22 of the movable strap 2 is sleeved to the mandrel 3 by the string 221 through a strap outlet groove 61. After the strap winding shaft 6 is driven by the hand wheel 4 to rotate, the winding end 22 can be wound on the strap winding shaft 6 layer by layer to form a tape storage.

Obviously, due to the unique design of the mandrel 3 and the strap outlet groove 61, the winding end 22 of the movable strap 2 does not need to pass before sewing and connecting, thus ensuring the simplification of the production process. Furthermore, the strap winding shaft 6 only undertakes the layer-by-layer winding of the movable strap 2, but the winding end 22 is connected to the mandrel 6, therefore, when the movable strap 2 wound on the strap winding shaft 6 is completely released in actual use, the winding end 22 will not break and damage the strap winding shaft 6, thereby not only ensuring the connection reliability of the winding end 22, but also avoiding affecting the subsequent normal use of the strap tensioner.

The above is only a specific embodiment of the present disclosure, and those skilled in the art should understand that any structural design equivalent to the embodiment is included in the protection scope of the present disclosure.

What is claimed is:

1. A storage strap winding structure for a contraction tensioner, comprising a ratchet strap tension apparatus (1) and a movable strap (2), a strap winding shaft (6) being arranged in an end portion of a fixed seat (11) of the ratchet strap tension apparatus (1), the movable strap (2) having a tension end (21) and a winding end (22), and the tension end being driven by the ratchet strap tension apparatus (1) to form tension, wherein the strap winding shaft (6) internally provided with a mandrel (3) which coaxially penetrates, and a strap outlet groove (61) exposing the mandrel (3) is arranged on the strap winding shaft (6); the winding end (22) is connected to the mandrel (3) through a strap outlet groove (61) and wound on the strap winding shaft (6) layer by layer by the rotation of the strap winding shaft (6) to form a storage strap.

2. The storage strap winding structure for a contraction tensioner according to claim 1, wherein the strap outlet groove (61), extending in an axial direction, is arranged on an outer surface of the strap winding shaft (6).

3. The storage strap winding structure for a contraction tensioner according to claim 1, wherein a string (221) sleeved on the mandrel (3) is arranged the winding end (22).

4. The storage strap winding structure for a contraction tensioner according to claim 1, wherein a hand wheel (4) in transmission connection is arranged at an end of the strap winding shaft (6) and drives the strap winding shaft (6) to rotate.

5. The storage strap winding structure for a contraction tensioner according to claim 4, wherein a polygonal shaft (62) and a polygonal hole (43) forming a transmission connection are arranged between the end of the strap winding shaft (6) and the hand wheel (4).

6. The storage strap winding structure for a contraction tensioner according to claim 5, wherein a positioning hole (64) is arranged in the polygonal shaft (62), a positioning shaft (44) is correspondingly arranged in the polygonal hole (43), and a transmission connection is formed between the end of the strap winding shaft (6),and the hand wheel (4) via the polygonal shaft (62) and the polygonal hole (43), while a positioning assembly is formed at the positioning hole (64) and the positioning shaft (44).

7. The storage strap winding structure for a contraction tensioner according to claim 1, wherein a storage strap seat (5) is arranged at the end portion of the fixed seat (11), pivot holes (51) are arranged at both sides of the storage strap seat, the end of the strap winding shaft (6) extends out of the pivot hole (51) to be in transmission connection to the hand wheel (4), and a stopping cap (63) is arranged at the other end of the strap winding shaft (6) extending out of the pivot hole (51).

8. The storage strap winding structure for a contraction tensioner according to claim 1, wherein the mandrel (3) penetrates from the end of the strap winding shaft (6) with the stopping cap (63) and coaxially penetrates along an axial line of the strap winding shaft (6) to form a connection to the hand wheel (4).

9. The storage strap winding structure for a contraction tensioner according to claim 1, wherein the hand wheel (4) is composed of a disc-shaped wheel body (41) and pivot blocks (42) symmetrically arranged on an outer circumferential surface of the wheel body, and a plurality of anti-slip grooves (45) are arranged on the outer circumferential surface of the wheel body (41).
